(19) United States
(12) Patent Application Publication
(10) Pub. No.: US 2018/0053252 A1
(43) Pub. Date: Feb. 22, 2018

(54) MOBILE CREDIT ACQUISITION WITH FORM POPULATION

(71) Applicant: Comenity LLC, Columbus, OH (US)

(72) Inventors: Adam KOLTNOW, Worthington, OH (US); Celeste RECHNER, Upper Arlington, OH (US); Tim PONTIOUS, Gahanna, OH (US)

(73) Assignee: Comenity LLC, Columbus, OH (US)

(21) Appl. No.: 15/341,988

(22) Filed: Nov. 2, 2016

Related U.S. Application Data
(60) Provisional application No. 62/408,554, filed on Oct. 14, 2016.
(60) Provisional application No. 62/375,851, filed on Aug. 16, 2016.

(51) Int. Cl. G06Q 40/02; G06F 17/30; H04W 4/12

(52) U.S. Cl. CPC G06Q 40/025; H04W 4/12; G06F 17/30867

(57) ABSTRACT

Mobile credit acquisition with form population is disclosed. The system includes a user specific information engine to receive a device identifier associated with a user's mobile device and a user identifier for a user of the user's mobile device. The user specific information engine using the device identifier and the user identifier to search for user specific information useable to populate an application form for a credit account. The search includes a proprietary database search for the user specific information, and a secondary source database search for the user specific information. The system utilizes an incentive provider to populate the application form for the credit account with found user specific information and provides the populated application form for the credit account to the user via the user's mobile device.

### CROSS-REFERENCE TO RELATED APPLICATIONS (PROVISIONAL)

This application claims priority to and benefit of co-pending U.S. Provisional Patent Application No. 62/408,554 filed on Oct. 14, 2016, entitled “MOBILE CREDIT ACQUISITION WITH FORM POPULATION” by Adam Koltnow et al., and assigned to the assignee of the present application, the disclosure of which is hereby incorporated herein by reference in its entirety.

This application claims priority to and benefit of co-pending U.S. Provisional Patent Application No. 62/375,851 filed on Aug. 16, 2016, entitled “MOBILE CREDIT ACQUISITION WITH FORM POPULATION” by Adam Koltnow et al., and assigned to the assignee of the present application, the disclosure of which is hereby incorporated herein by reference in its entirety.

### BACKGROUND

Company specific, brand specific or even store specific credit accounts provide significant value to both consumer and provider. By issuing a store specific credit account, the provider is able to tailor rewards offers, provide loyalty discounts and maintain consumer brand loyalty. Similarly, the consumer receives the perks from the reward offers and the loyalty discounts. In addition, a user receiving the rewards and discounts will often recommend the credit account to friends via word of mouth, social networks, internet rating sites, and the like.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1A is a block diagram of a mobile credit acquisition system, in accordance with an embodiment.

FIG. 1B is a block diagram of a user specific information engine accessing one or more different search locations, in accordance with an embodiment.

FIG. 2A is a flow chart of a method for mobile credit acquisition, in accordance with an embodiment.

FIG. 2B is a flow chart of a method for utilizing the device identifier and the user identifier to obtain user specific information, in accordance with an embodiment.

FIG. 3A is a block diagram of a mobile credit acquisition as viewed on a user's mobile device, in accordance with an embodiment.

FIG. 3B is a block diagram of a mobile direct credit application as viewed on a user's mobile device, in accordance with an embodiment.

FIG. 3C is a block diagram of another embodiment for mobile credit acquisition as viewed on a user's mobile device, in accordance with an embodiment.

FIG. 3D is a block diagram of an embodiment for mobile credit acquisition having prepopulated form information as viewed on a user's mobile device, in accordance with an embodiment.

FIG. 4 is a block diagram that illustrates an embodiment of a retail establishment for mobile credit acquisition in accordance with an embodiment.

FIG. 5 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “correlating”, “prescreening”, “developing”, “presenting”, “deploying” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview

Mobile credit acquisition is discussed herein. In one embodiment, the offer and acceptance occur via interaction with the user through the user's mobile device. In one embodiment, by providing the offers and responses via the user's mobile device the user can receive and review the offer at a less stressful location as compared to when the offer is made by an associate at the point of sale (POS). That is, by moving the offer and acceptance away from the POS the user does not feel “put on the spot” or rushed by other customers in line, etc.

Moreover, after finding out information about the client, that information can be used for pre-population form filling when forms are provided to the user on the mobile device. In other words, many fields in an application will be pre-populated which will reduce the amount of work a user has to do inputting the information. This work reduction will allow the process to flow faster and reduce user form abandonment.

In general, form abandonment occurs when a user needs to fill out a form and the form has a number of questions that need answers. In other words, the more questions that need answers, the more likely that a user will abandon the form before completion. Thus, if the form is prepopulated with information, there will be fewer blanks for the user to fill in in order to complete the form. The fewer blanks will allow the form to be completed before the user becomes frustrated, distracted, overwhelmed, or the like. As such, the percentage of users completing the credit application form will increase as the amount of questions that need answers input by the user decrease.

Importantly, the embodiments of the present invention, as will be described below, provide a mobile credit acquisition with form population which differs significantly from the conventional processes used for consumers to apply for a credit account. In conventional approaches, when filling out the forms to apply for credit, the consumer must key in a lot of information such as name, address, phone number, birthday, identification number, etc. Such conventional approaches are error prone, tedious, time-consuming, and often times a user will quit the process before it can be completed. Instead, the present embodiments, as will be described and explained below in detail, provide a previously unknown procedure for reducing the amount of data a consumer has to key by locating the consumer's name, address and other personal information via automated searches. Thus, embodiments of the present invention provide a streamlined method for mobile credit acquisition which extends well beyond what was previously done by hand.

As will be described in detail, the various embodiments of the present invention do not merely implement conventional mobile credit acquisition processes on a computer. Instead, the various embodiments of the present invention, in part, provide a previously unknown procedure for reducing the amount of data a consumer has to key by locating the consumer's name, address and other personal information via automated searches. Hence, embodiments of the present invention provide a novel process for mobile credit acquisition with form population which is necessarily rooted in computer technology to overcome a problem specifically arising in the realm of digital customer key fatigue.

Moreover, the embodiments do not recite a mathematical algorithm; nor do they recite a fundamental economic or longstanding commercial practice. Instead, they address a business challenge, the loss of credit applications due to key fatigue. Another key benefit is if the consumer is approved for the brand credit account they are presented with a temporary account for immediate use, providing an excellent consumer experience, thus, building brand loyalty and potential incremental spend for the brand. Thus, the embodiments do not “merely recite the performance of some business practice known from the pre-Internet world along with the requirement to perform it on the Internet. Instead, the embodiments are necessarily rooted in retail purchase technology in order to overcome a problem specifically arising in the realm of customer application fatigue.”

For purposes of the discussion, a user's mobile device may be a mobile phone, a smart phone, a tablet, a smart watch, a piece of smart jewelry, smart glasses, and other user portable devices having wireless connectivity. That is, the mobile device would be capable of broadcasting and receiving via at least one network, such as, but not limited to, WiFi, Cellular, Bluetooth, NFC, and the like. In one embodiment, the mobile device may have a positioning determining system. In another embodiment, the mobile device may be able to determine location within a given radius, such as the broadcast range of a beacon, WiFi hotspot, overlapped area covered by a plurality of mobile telephone signal providers, or the like.

In the following discussion, the term “prescreen” is utilized. In general, prescreen refers to a credit prescreen for a user. That is, a screening of a user based on some sort of identification information that allows a likely credit determination to be performed via a credit reporting agency. For example, if Consumer 1 is pre-screened, identifying information would be obtained, such as, his name and current address. The name and current address would be used to perform a credit check of Consumer 1's credit history and qualifications based on the credit issuer's selection criteria. In one embodiment, the check may occur at one of a number of possible credit reporting agencies. However, in another embodiment, the check of Consumer 1's credit history may be limited, such as, to his credit history with one given credit reporting agency.

It should be appreciated that the obtaining or accessing of user information conforms to applicable privacy laws (e.g., federal privacy laws, state privacy laws, etc.) and applicable fair credit reporting act laws. In one embodiment, prior to accessing user information, the user affirmatively “opts-in” to the services described herein. For example, during the use of an issuer's mobile application, the user is prompted with a choice to affirmatively “opt-in” to various services. As a result, any information is obtained with the user's prior permission.

Moreover, depending on present or future credit prescreening requirements, rules and regulations, the credit prescreen described herein may be more or less formal. For example, if the legislation requires a user be informed, or provide authorization, before a review of the user's credit score is authorized, the credit prescreen described herein would be modified to remain within the meets and bounds of the applicable laws.

### Operation

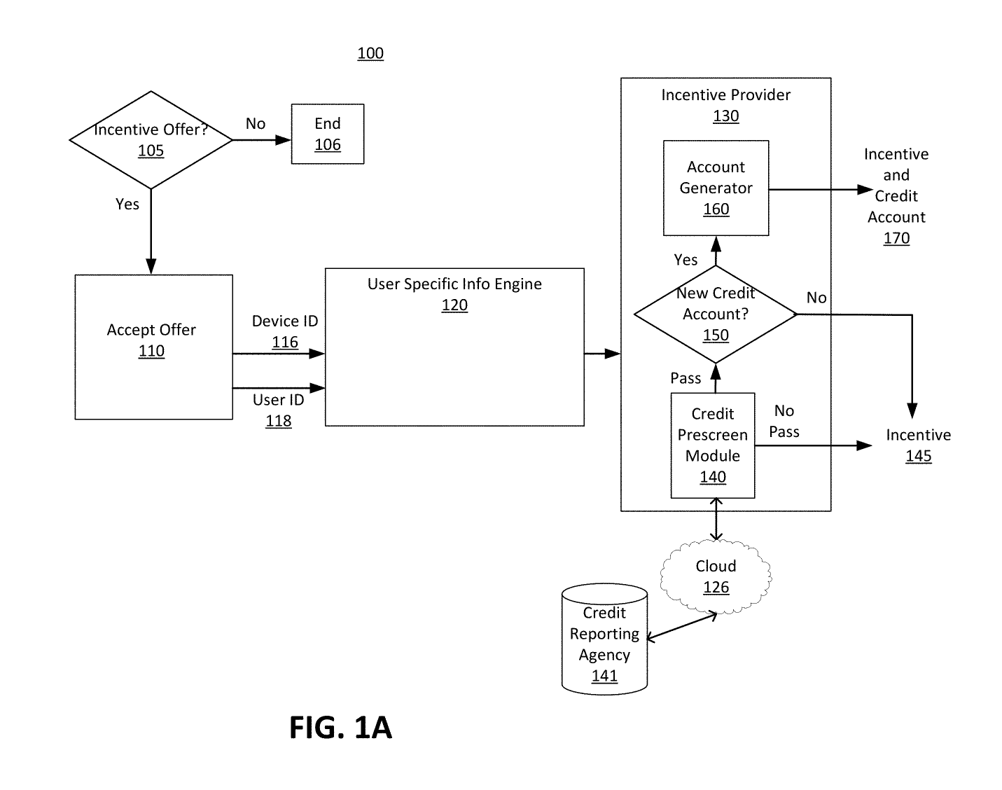

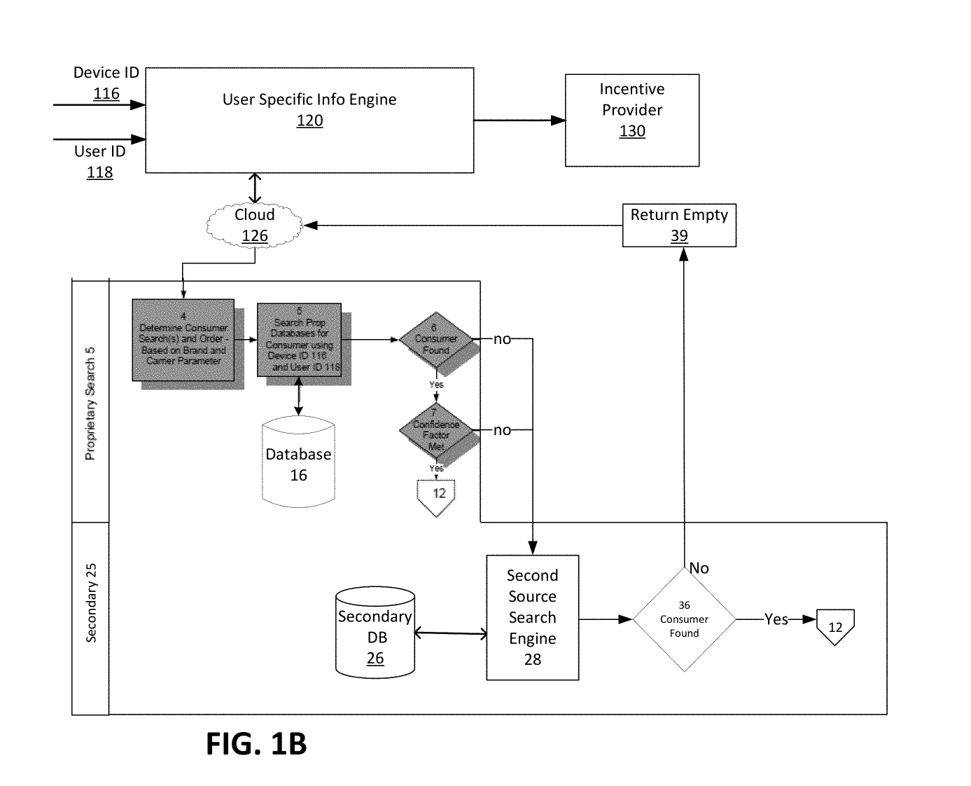

Referring now to FIG. 1A, a block diagram of a mobile credit acquisition system 100 is shown in accordance with an embodiment. In one embodiment, mobile credit acquisition system 100 includes an incentive offer 105, an offer acceptance 110, a user specific information engine 120 and an incentive provider 130. Although a number of applications and components are shown in mobile credit acquisition system 100, it should be appreciated that the components and applications may be located separately from one another. For example, one or more of the components and applications may be found on one or more locations, such as, but not limited to a computer in the retail store, a server at a remote location, on the cloud 126 or the like.

In general, offer 105 is an incentive offer for a user intended to be redeemed via a user's mobile device. For example, offer 105 may be a digitally redeemable incentive, an offer for a credit account, or the like. For example, the offer may be a discount percentage, a free gift, a coupon, a surprise gift, a surprise reward, or the like. Offer 105 may be located on a physical item such as a poster, or the like and include a visual code such as a barcode, a QR code, a number to text, an email address to reply to, or the like. In another embodiment, offer 105 is received by the user's mobile device, e.g., via a beacon broadcast, WiFi broadcast, email, text, SMS, social media alert, app alert, or the like. In yet another embodiment, offer 105 may be provided by an app on the user's mobile device once the mobile device is within a certain vicinity of the store providing the offer.

If a user does not chose to accept offer 105 then the system goes to end 106 and no further actions are taken.

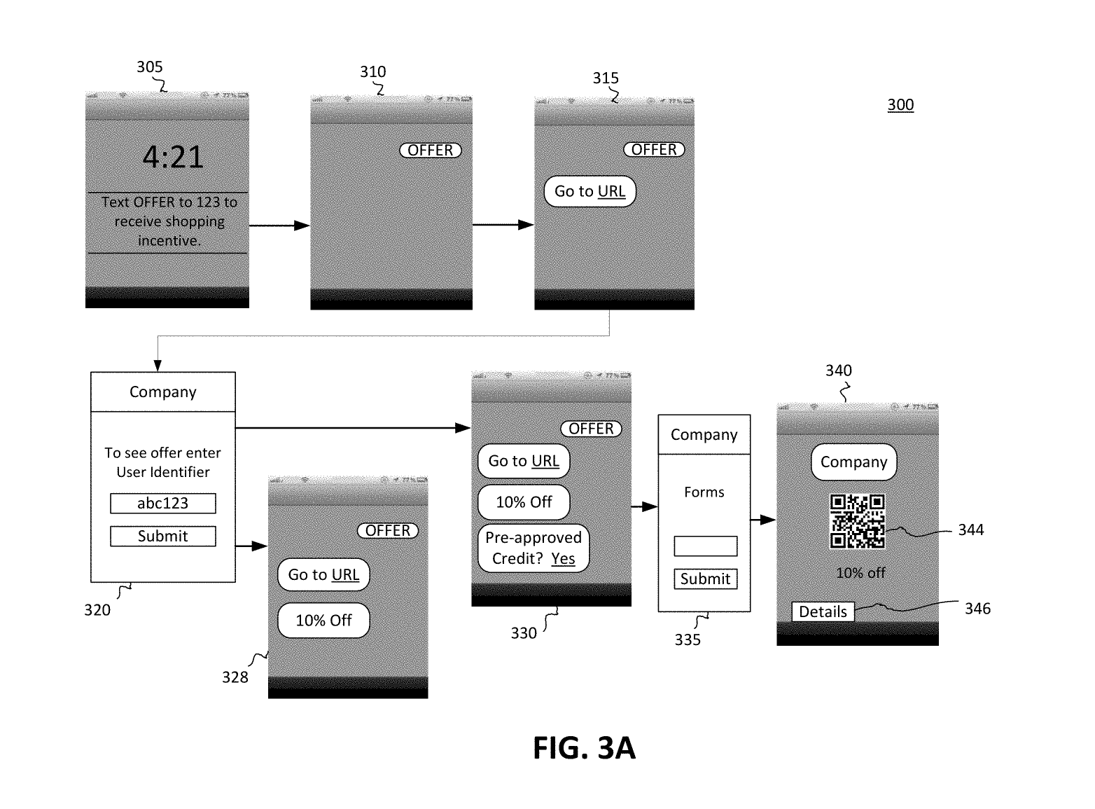

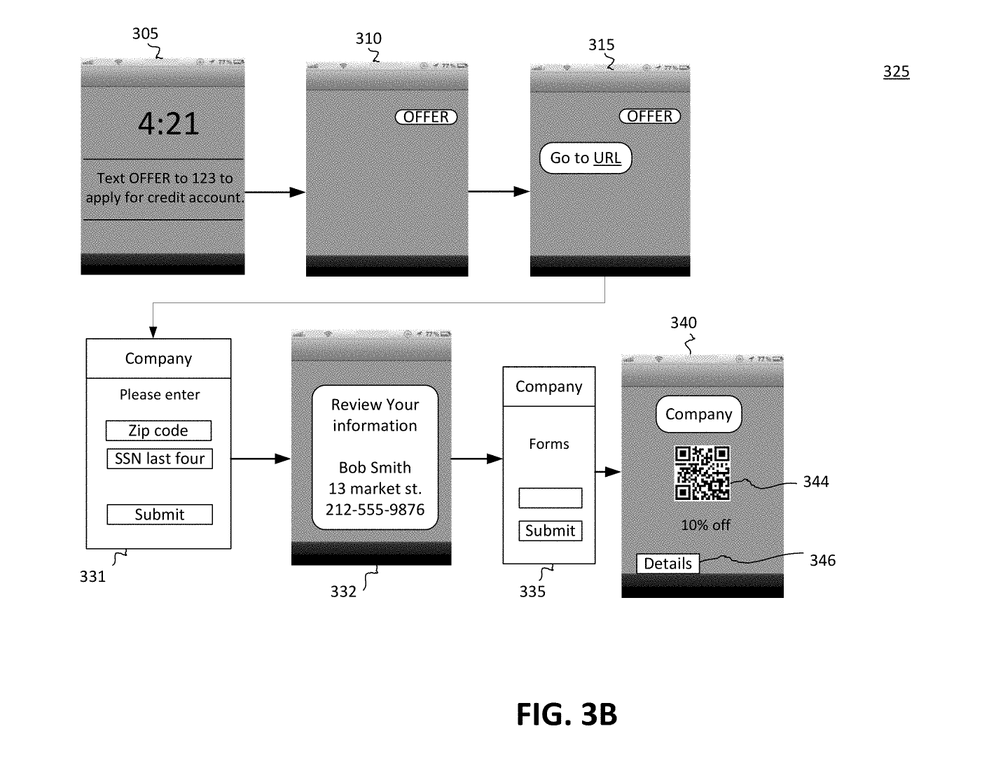

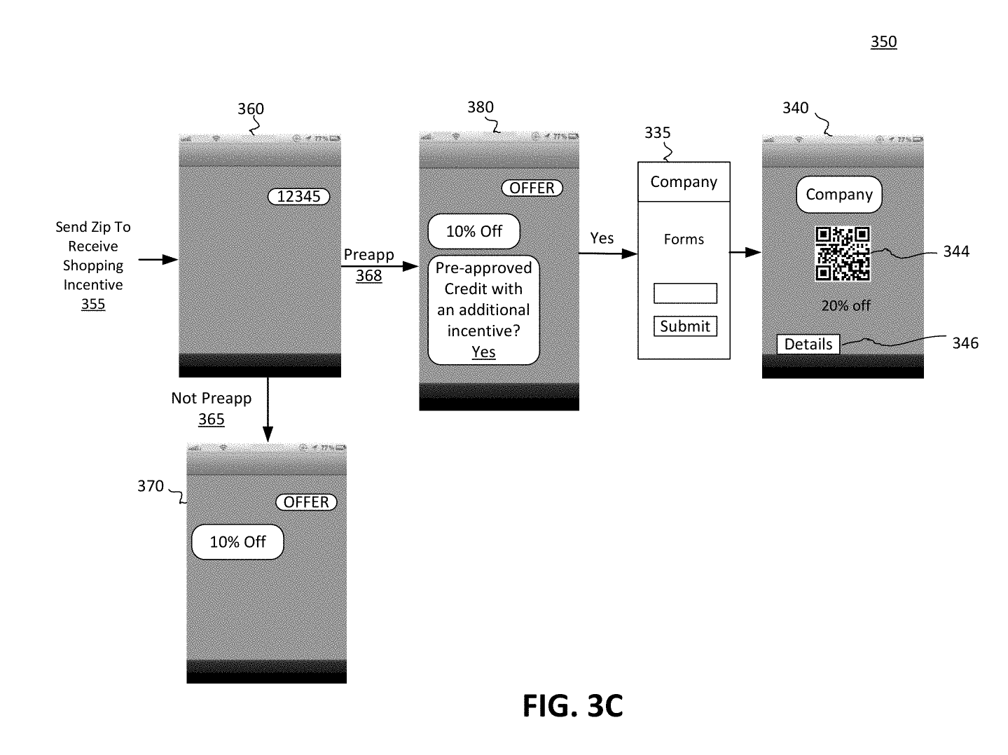

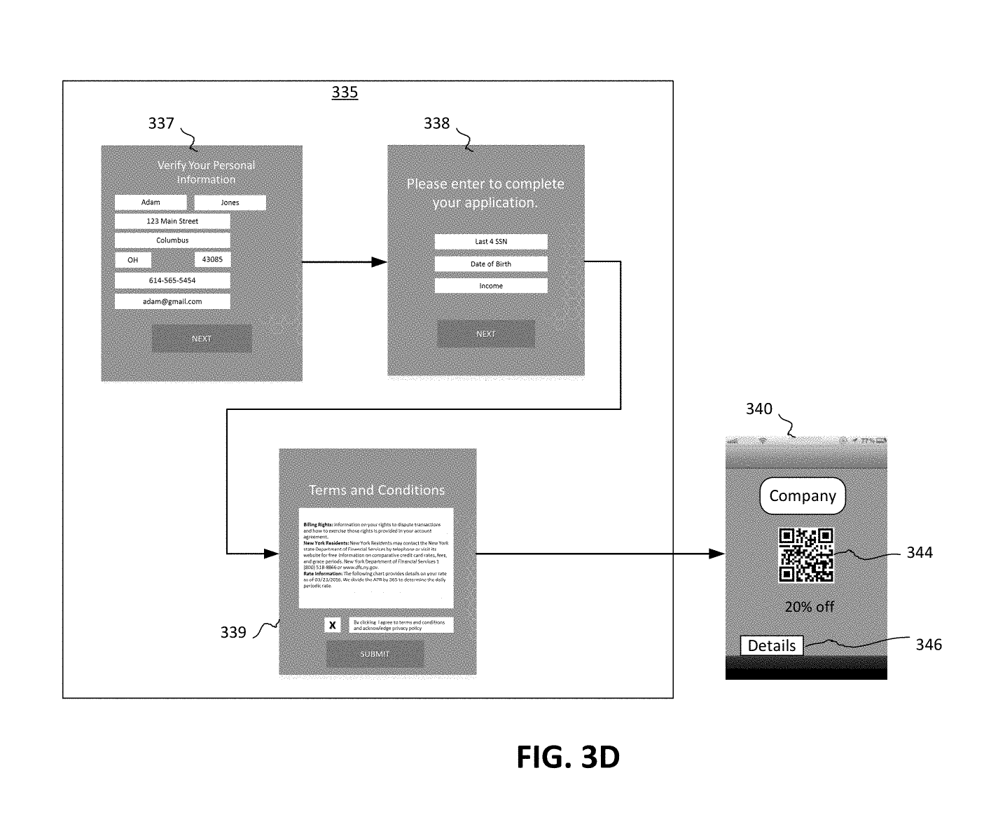

At offer acceptance 110, a number of different options may be available to accept the offer 105. For example, the offer acceptance may be in the form of a message interaction such as shown and described in further detail in FIGS. 3A through 3D. In one embodiment, offer acceptance 110 includes providing a mobile device ID 116 and a user ID 118.

In general, device ID 116 can be the mobile device's phone number, SIM card integrated circuit card identifier (ICCID), unique device identifier (UDID), or the like.

User ID 118 can be the user's zip code, social security number or portion thereof, driver's license number or portion thereof, or the like that is used to identify a specific user.

Thus, a user's acceptance of offer 105 will include enough information for the mobile credit acquisition system 100 to perform a prescreen of the user for purposes of offering the user an opportunity to obtain a credit account.

In one embodiment, user specific information engine 120 will receive the message accepting the digitally redeemable incentive, from a user's mobile device. The acceptance message will include device ID 116 and user ID 118.

In one embodiment, user specific information engine 120 will use device ID 116 and user ID 118 to obtain user specific information useable for a credit prescreen and/or to prepopulate an electronic form such as a credit application. In general, user specific information could be at least two of: a name and full or partial address, a driver's license number, a social security number, or the like.

As shown in FIG. 1B, user specific information engine 120 may access the different search locations via the cloud 126. An example of cloud 126 is a network such as the Internet, local area network (LAN), wide area network (WAN), or the like.

One embodiment uses the device ID 116 and user ID 118 information to perform a proprietary search 5 of at least one proprietary database 16. In general, the proprietary database 16 may be one or more databases such as a credit accounts database, or the like, that store a company's private database such as an Alliance Data Legacy database or the like. Proprietary database 16 will include user specific information for customers that have existing accounts with the company, have previously applied for an account, or the like.

In one embodiment, the proprietary search 5 will only search a database related to a specific company. For example, if the incentive provider is a specific company, e.g., Nash's skate and bike emporium, then in a company specific database search, only the existing customer information related to Nash's skate and bike emporium will be searched. For example, a check is performed to see if the customer has an existing brand account, e.g., is already an existing customer in the database.

However, if the proprietary search 5 is for a group of companies, a shared information database, or the like, then all of the customer information in the databases may be searched for a match with the device ID 116 or the user ID 118. For example, if the database includes Nash's skate and bike, Mike's hardware, and Tarrin's dress stores, and all three companies are sharing information, then the search would encompass all three store's databases of information.

For example, search an internal accountholder database to see if the consumer has another account within the shared information database. For example, if the customer does not have a Nash's skate and bike account, the underlying credit account, e.g., Alliance Data database is searched to see if the customer has an account at a different brand associated with Alliance Data.

In one embodiment, consumer information 6 that is found in the proprietary database 16 will be verified using a confidence factor 7. For example, if only one record is found and it is 5 days old, the confidence in the found records would likely be below a confidence threshold. In contrast, if 2 years of records are found, records such as prior accounts, present accounts, memberships, rewards information, and the like, then the confidence in the user specific information found in the records would be above the confidence factor threshold. If the user specific information is above the confidence threshold, then the user specific information is deemed valid. At that point, the user specific information is returned via return information 12 to user specific info obtainer 120 and then passed on to incentive provider 130 as discussed and shown in FIG. 1A.

### Validation Using Fraud Business Rules

One embodiment incorporates one or more of several fraud mitigation business rules to attempt to prevent fraudulent activity; e.g., to validate the found records. These business rules include logic that look at specific activity on a consumer's account that point to potential fraudulent activities. In addition, fraud mitigation tool may be implemented. The fraud mitigation tool will use device and internet protocol (IP) information to predict if the credit application can be trusted or will eventually become fraudulent.

For example, in one embodiment, the fraud mitigation will ignore any credit accounts that meet situations such as, but not limited to, the following. It is associated within a brand(s) that have been determined to have a high propensity for fraud. It is currently in a derogatory status. The account was opened within a defined number of days, where the number of days is controlled by internal parameter and can be tightened, loosened or turned off. The phone number matched has been changed within a defined number of days, where the number of days is controlled by internal parameter and can be tightened, loosened or turned off. An authorized buyer has been added to the account within a defined number of days, where the number of days is controlled by internal parameter and can be tightened, loosened or turned off. The address has been changed within a defined number of days, where the number of days is controlled by internal parameter and can be tightened, loosened or turned off. The account has been inactive within a defined number of months, where the number of months is controlled by internal parameter and can be tightened, loosened or turned off. Multiple accounts are found for the mobile phone number, zip code and last 4 digits of the SSN but all accounts are not the same person; and the like.

If no user specific information is found during the proprietary search 5 or if the found user specific information cannot be validated, then the device ID 116 and user ID 118 are passed on to a secondary search 25. At secondary search 25, a second source search engine 28 will search at least one secondary source database 26. One example of secondary source database 26 is a reverse phone number look up such as reverse phone look-up. However, other secondary source databases may be searched such as, but not limited to: social media sites, search engines, online public and/or private records, reverse name and phone number engines, and the like. In one embodiment, the user specific information may be obtained by performing a secondary source database 26 search with the user ID 118 and the device ID 116.

In one embodiment, the secondary search 25 may be for example, a real-time call to a reverse phone look-up product to try and locate the consumer. In general, reverse phone look-up products provide accurate and current consumer telephone information. In many cases, the data is updated regularly from a broad range of sources, including regional bell operating companies, white pages and proprietary sources. One embodiment also integrates validation and authentication aspects that add further benefits to append address information for a consumer. In general, validation and authentication aspects match consumer name and zip code information that was returned from the reverse phone look-up, against data from a secondary source to return full address data.

If consumer information 36 is found then the user specific information is returned via return information 12 to user specific info obtainer 120. If no user specific information is found from the secondary sources 25, then no user specific information will be pre-populated into the forms. That is, the user specific info obtainer 120 will receive a return empty 39. However, if a match is made, then the user specific information can be used to prepopulate a portion of the application. E.g., name, address, city, state, zip, mobile phone number, email, etc. of the application.

This is a benefit of the mobile credit acquisition with form population capability. Utilizing the form population reduces the amount of data a consumer has to key by locating the consumer's name and address via automated searches.

In another embodiment, when a consumer has to enter or change their address and begins to type their address, a search is invoked that returns a list of potential results based on the zip code that was entered in the initial user experience. As more characters are typed the picklist is refined to display closer matches. When the address is selected, it will be checked for completeness and the associated city and state will be auto pre-filled

Referring now back to FIG. 1A, user specific information engine 120 will provide the user specific information to incentive provider 130. In one embodiment, incentive provider 130 includes a credit prescreen module 140, a new credit account offer 150 and a credit account generator 160. Although a number of applications and components are shown, it should be appreciated that there may be more of fewer components and applications of incentive provider 130. Moreover, different pieces may be combined, re-organized, located separately from one another, or the like.

In general, credit prescreen module 140 accesses a credit reporting agency 141 via cloud 126 to determine credit information for the user based on the identification information. An example of cloud 126 is a network such as described herein. The credit reporting agency 141 may be a company such as, but not limited to, Experian, Equifax, TransUnion, Innovis and the like.

Credit prescreen module 140 will analyze the user's credit information provided by credit reporting agency 141 to determine if the user passes a prescreen credit criteria. In one embodiment, credit prescreen module 140 will also receive a minimum credit amount. In general, minimum credit amount refers to a minimum credit limit for the user to prequalify. For example, the minimum credit amount may be 500.00 USD. In the case where credit prescreen module 140 receives a minimum credit amount, credit prescreen module 140 will utilize the user's credit information provided by credit reporting agency 141 in conjunction with the minimum credit amount requirement to determine if the user is reasonably likely to receive an acceptable credit line if approved upon application for credit.

If the user does not pass the prescreen, the digitally redeemable incentive 145 is provided to the user's mobile device and no further action is taken by mobile credit acquisition system 100. Thus, regardless of whether or not the user passes the prescreen, the incentive 145 is provided to the user.

In one embodiment, if the user does pass the credit prescreen then new credit account 150 provides an offer for a credit account to the user's mobile device. In one embodiment, new credit account 150 populates the offer for a credit account as shown in FIG. 3D. That is, credit account 150 will place the user specific information provided by the user specific information engine 120 into the forms that are provided to the user's mobile device. By populating the forms prior to presenting them to the user, the abandonment rate will be improved as the acceptance process will be shortened due to the pre-filling of the customer's information into the acceptance forms.

In one embodiment, the pre-approved credit offer is provided in conjunction with the digitally redeemable incentive 145. In one embodiment, an additional incentive offer is also provided to the user, wherein the additional incentive becomes available after the user successfully completes the pre-approved credit offer.

If the user does not respond to the new credit account offer, then no further action is taken by mobile credit acquisition system 100.

However, if the user does accept the new credit account offer, then credit account generator 160 generates a new credit account and provides the incentive and credit account 170. That is, credit account generator 160 provides a digital credit account identifier at the mobile device after the user successfully completes the pre-approved credit offer. In one embodiment, the digital credit account identifier is instantly available to be used as a form of payment. Additional details regarding the digital credit account identifier are shown and described with reference to FIGS. 3A through 3D herein.

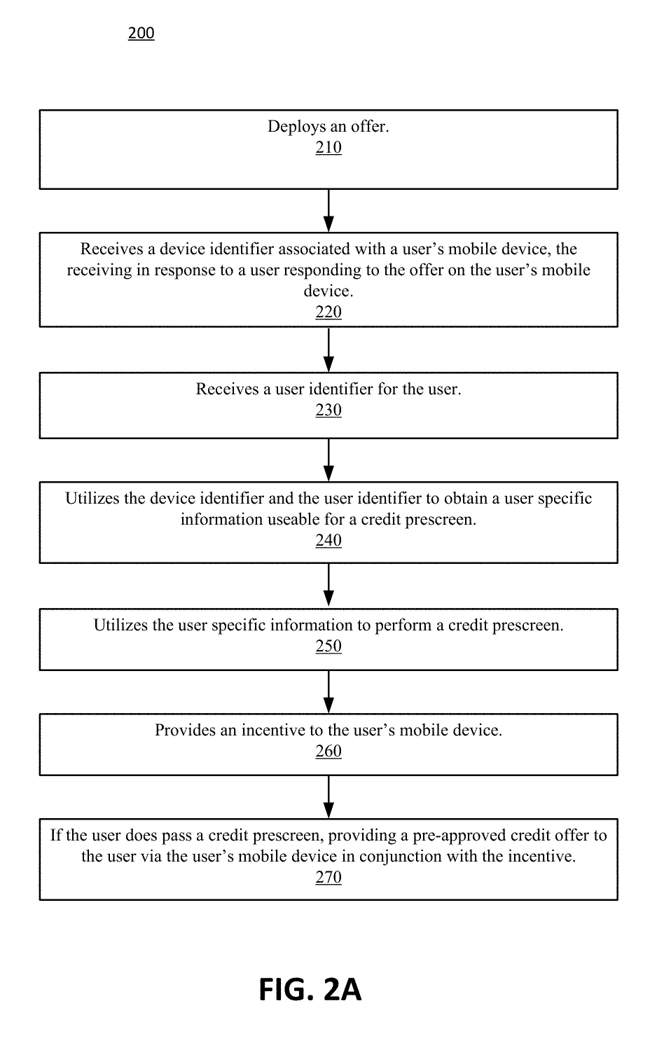

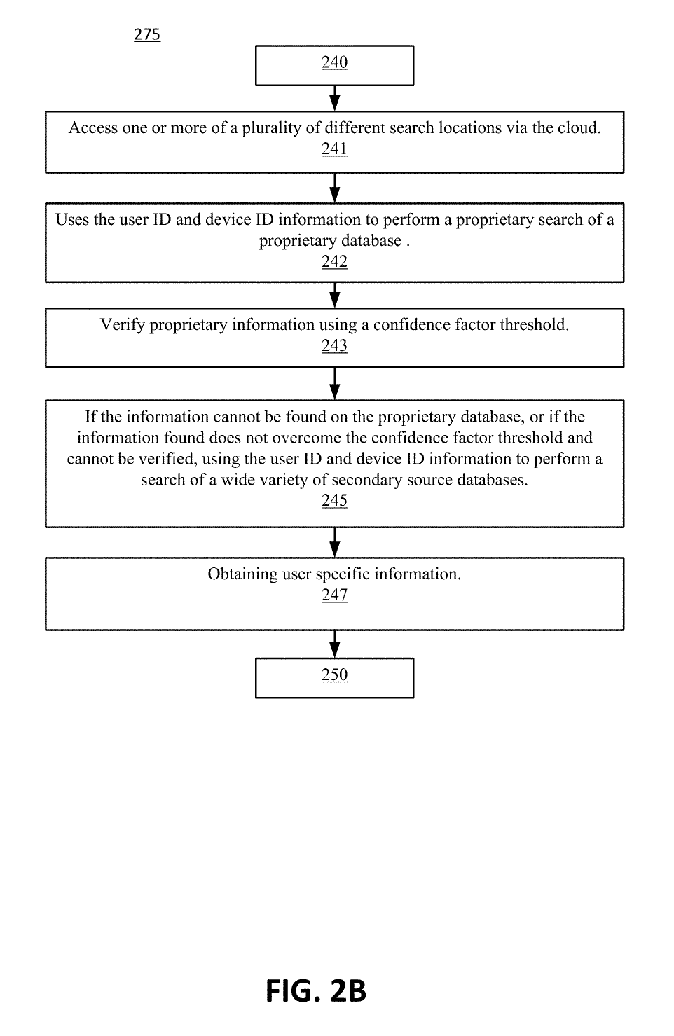

With reference now to FIG. 2A, a flowchart 200 of a method for mobile credit acquisition is shown in accordance with an embodiment. FIGS. 3A through 3D are also utilized to provide clarity and support for the discussion of flowchart 200. FIG. 3A is a block diagram 300 of a mobile credit acquisition as viewed on a user's mobile device shown in accordance with an embodiment. FIG. 3B is a block diagram of a mobile direct credit application as viewed on a user's mobile device, in accordance with an embodiment. FIG. 3C is a block diagram 350 of another embodiment for mobile credit acquisition as viewed on a user's mobile device is shown in accordance with an embodiment. FIG. 3D is a block diagram of an embodiment for mobile credit acquisition having prepopulated form information as viewed on a user's mobile device. Although the interactions between user's mobile device and the offeror are shown in the format of text messages, it should be appreciated that the interactions may be made via one or more of: a beacon broadcast, WiFi broadcast, email, text, SMS, social media alert, app alert, or the like.

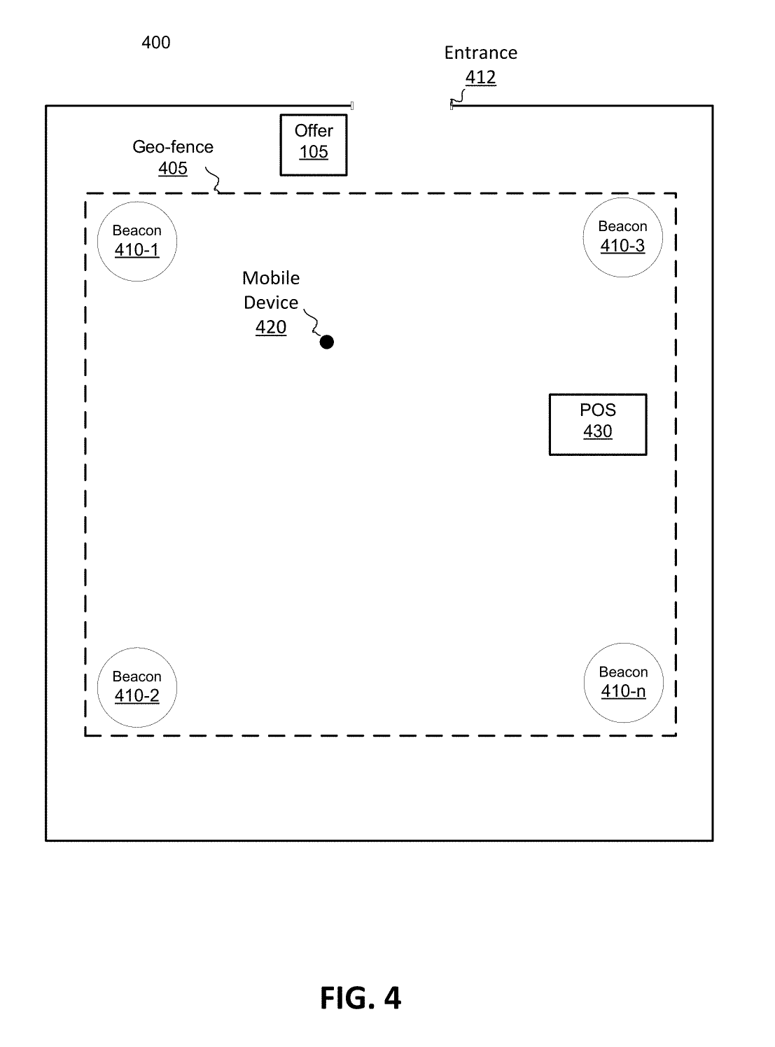

With reference now to 210 of FIG. 2A, one embodiment deploys offer 105. One embodiment deploys the offer 105 in a physical location within a retail store such as shown and described with reference to FIG. 4 herein. In another embodiment, offer 105 is provided to the user's mobile device when a location of the user's mobile device is in proximity to a retail store. In one embodiment, offer 105 may be an incentive of a reward of some kind, an opportunity or an incentive to open a credit account with the retailer, or the like.

For example, offer 105 is distributed on a physical item such as a poster, or the like that includes a visual code such as a barcode, a QR code, a number to text, an email address to reply to, or the like. In another embodiment, offer 105 is received by the user's mobile device, e.g., via a beacon broadcast, WiFi broadcast, email, text, SMS, social media alert, app alert, or the like. In yet another embodiment, offer 105 is provided by an app on the user's mobile device that will present offer 105 once the mobile device is within a certain vicinity of the store providing the offer.

With reference now to 220 of FIG. 2A, one embodiment receives a device identifier associated with a user's mobile device, the receiving in response to a user responding electronically to the offer on the user's mobile device. Device ID 116 may be the mobile device's phone number, SIM card integrated circuit card identifier (ICCID), unique device identifier (UDID), or the like.

For example, as shown in FIG. 3A at 305 the user receives an offer 105 that requests a text be sent to 123 to receive the incentive. At 310 when the user texts “offer” to 123, the user's device ID 116 will be available.

With reference now to 230 of FIG. 2A, one embodiment receives a user identifier for the user. User ID 118 may be the user's zip code, social security number or portion thereof, driver's license number or portion thereof, or the like.

For example, as shown in FIG. 3A at 315 the user receives a response that includes a URL. When the user clicks on the link, the user is led to a company page 320 that asks the user to provide a user ID 118. In one embodiment, the company page 320 is a web page, a micro page or the like. After the user submits a response to page 320, the user ID will be received. In one embodiment, the response will be a providing of the zip code associated with the user of the mobile device.

In another example, as shown in FIG. 3B when the offer is to apply for a credit account, at 315 the user receives a response that includes a URL. When the user clicks on the link, the user is led to a company page 331 that asks the user to provide a zip code and a last four of a social security number as the user ID 118. Although the last four of a social is shown as the user ID 118, it should be understood that the user ID 118 may be something other than the last four of a social security number, such as user's zip code, entire or a different portion of a social security number, the driver's license number or portion thereof, or the like; that is used to identify a specific user.

In another embodiment, 220 and 230 of FIG. 2A may be performed in a single step, such as shown in FIG. 3C. For example, at 355 of FIG. 3C, the offer asks the user to send her zip code as the initial response to receive the incentive. At 360, when the user sends the zip code, both the user ID 118 and the device ID 116, will be received. That is, in a single response from the user accepting the incentive offer.

### Customer Information Acquisition

With reference now to 240 of FIG. 2A and as shown and expanded in the flowchart 275 of FIG. 2B, e.g., a method for utilizing the device identifier and the user identifier to obtain user specific information, one embodiment utilizes device ID 116 and user ID 118 to obtain user specific information useable for a credit prescreen and/or to prepopulate an electronic form such as a credit application. In general, user specific information could be one or more of: a name and full or partial address, a driver's license number, a social security number, or the like.

As shown at 241 of FIG. 2B, user specific information engine 120 may access one or more of a plurality of different search locations via the cloud 126. An example of cloud 126 is a network such as the Internet, local area network (LAN), wide area network (WAN), or the like.

As described at 242 of FIG. 2B, one embodiment uses the device ID 116 and user ID 118 information to perform a proprietary search 5 of a proprietary database 16. In general, the proprietary database 16 may be one or more databases that store a company's private database such as an Alliance Data Legacy database or the like. Proprietary database 16 will include user specific information for customers that have existing accounts with the company, have previously applied for an account, or the like.

With reference now to 243 of FIG. 2B, in one embodiment, user specific information that is found in the proprietary database 16 will be verified using a confidence factor threshold. For example, a confidence factor determination will be made by looking at the returned records to determine a confidence value. For example, if only one record is found and it is 5 days old, the confidence in the found records would likely be below the confidence value threshold. In contrast, if 2 years of records are found, records such as prior accounts, present accounts, memberships, rewards information, and the like, then the confidence value in the user specific information found in the records would be above the confidence factor threshold. If the user specific information does pass the confidence threshold, then the user specific information is returned via return information 12 to user specific info obtainer 120 and then passed on to incentive provider 130 as discussed and shown in FIG. 1A.

With reference now to 245 of FIG. 2B, if the user specific information cannot be found on the proprietary database, or if the user specific information found does not overcome the confidence factor threshold, one embodiment uses the user ID 118 and device ID 116 information to perform a search of a secondary source database 26. Examples of secondary source databases include Internet engines such as Google, Equifax, Experian, Yahoo, and the like. In one embodiment, the user specific information may be obtained by performing an internet search with the user ID 118 and the device ID 116. For example, the search may include social media sites, search engines, online public records, and the like.

As shown at 247 of FIG. 2B, in one embodiment the user specific information is provided via return information 12 to user specific info obtainer 120 and then passed on to incentive provider 130 as discussed herein and shown in FIG. 1A.

In one embodiment, if no user specific information is found by secondary source engine 28, or if the user specific information found does not reach the threshold of the confidence factor, the user specific info obtainer 120 will receive a return empty 39.

With reference now to 250 of FIG. 2A, one embodiment utilizes user specific information to perform a credit prescreen. In one embodiment, the prescreen is performed at a credit reporting agency 141. However, in another embodiment, the prescreen may not be performed at a credit reporting agency but will instead be based on other aspects, such as, but not limited to, the user's mobile carrier account history, the user's home ownership and the like. For example, if a user is identified as being a home owner, the offer of credit may be provided without need of a prescreen being performed at a credit reporting agency.

Referring now to 260 of FIG. 2A, one embodiment provides the incentive to the user's mobile device. For example, at 328 of FIG. 3A, the user receives the 10% off offer. Similarly, in FIG. 3C, if the user is not pre-approved 365 then at 370 the user receives the 10% offer. Although the offer is shown as being 10% off, that is merely for purposes of clarity. The offer may be any of the types such as described in conjunction with FIGS. 1A and B.

In one embodiment, as shown in FIG. 3B, if the offer is to open a credit account then the user will be presented with a screen 332 that includes the found information being presented to the user. The user can confirm that the information is correct and that information will then be used to prepopulate the forms at page 335 as described herein.

With reference now to 270 of FIG. 2A, if the user does pass a credit prescreen, one embodiment provides a pre-approved credit offer to the user via the user's mobile device in conjunction with the incentive. For example, at 330 of FIG. 3A, the user receives the 10% off offer and also receives a pre-approved credit offer at the user's mobile device.

In addition, one embodiment provides an additional incentive offer to the user, the additional incentive available when the user successfully completes the pre-approved credit offer. For example, as shown in 380 of FIG. 3C, the user receives the 10% off offer and also receives an additional incentive provided with the offer for the pre-approved credit account at the mobile device. In one embodiment, the additional incentive becoming available after the user successfully completes the pre-approved credit offer.

In one embodiment as shown in FIG. 3C, offer 105 is only for a credit account. That is, instead of providing an offer for a reward and then performing a prescreen, the user may initially text for the credit account offer. In so doing, there will likely be fewer steps involved than those discussed above. Thus, looking at FIG. 3C, there would be no initial offer provided to the mobile device but instead after the user texted the user ID 118 (at which time the device ID 116 would also be acquired) as shown in 355 and 360, the prescreen would occur and the user would not see screen 380. If the prescreen was successful and the user did meet the prescreen requirements, the flow would jump over 380 and straight to 335 were the user would be able to begin the application process.

With reference now to FIG. 3D the flow of 335 is shown in additional detail. In one embodiment when the user accepts the pre-approved credit offer, the user is directed to a credit application acceptance page(s). In one embodiment, credit application information is pre-filled with the information previously obtained as shown at screen shots 337-339.

In general, screen shot 337 is pre-filled with the information obtained by user specific info obtainer 120. That is, the information such as name, address, city, state, phone number, email and the like, would be prefilled. Thus, instead of having to type in the information, the user would simply verify that the information is correct and make any changes accordingly. Similarly, if some of the information was missing, the user would be able to fill in only the missing portions without having to complete the entire form. Thus, the user would see a significant number of keystroke reduction in the pre-filled forms which would increase throughput, decrease frustration and the time needed to fill out the forms.

Once verified, the user would go to next screen shot 338 where additional application information would be needed. In screen shot 338, the information includes last 4 of ssn, date of birth, and income. However, it should be appreciated that the information on either of screen shot 337, 338 or 339 may be different, to include less, additional, or other information.

Once the user had completed filling out the information on screen shot 338 (some of which may also be auto-filled depending upon the information requested), the user would hit the next button and then be provided with the terms and conditions as shown in screen shot 339. In one embodiment, the terms and conditions would include a signature portion. Once the user signed and submitted the terms and conditions screen shot 339, the user would then be presented with the new account information as described in 340.

With reference now to 340 of FIGS. 3A and 3C, one embodiment provides a digital credit account identifier 344 to the user's mobile device when the user successfully completes the pre-approved credit offer, the digital credit account identifier 344 instantly available to be used as a form of payment. For example, the digital credit account identifier 344 received at the mobile device may be a QR code, bar code, digital image of a credit card, or other type of identifier for providing credit account information digitally to a POS.

One example of a digital credit account identifier 344 may be a temporary shopping pass which may include: the user's name, credit limit, store card account number, terms of use for the temporary shopping pass, a rotating GIF to prevent screenshots from being accepted at POS, a banner asking customer to present their ID to the associate to use the temporary account, or the like.

Thus, by prescreening the user and providing an offer to apply for store credit only to a prequalified user, the concern of embarrassing the user due to denial of credit is reduced. Moreover, by providing the offer to the user on the user's mobile device, the store can move the interaction and offer away from the register area.

Referring now to FIG. 4, a top plan view of a retail store 400 is shown in accordance with an embodiment. In general, retail store 400 is any physical brick and mortar store that provides goods for sale at the store location. In one embodiment, retail store 400 includes an entrance 412. In addition, in different embodiments and configurations, retail store 400 can include one or more of, offer 105, geo-fence 405, beacons 410-1 through 410-n, point of sale (POS) 430

In one embodiment, the offer 105 may be provided based on a location of a user as determined by the user's mobile device 420. For example, if the location of the offer 105 is static, such as by the entrance 412 to retail store 400, then when the user's mobile device 420 utilizes information found in offer 105, it would be likely that the user is located near retail store 400. For example, the offer 105 may be a physical item such as a poster, or the like and include a visual code such as a barcode, QR code, or the like. As such, offer 105 may be scanned to be redeemed.

Similarly, if the offer is provided via a beacon such as one or more of beacons 410-1 through 410-n the user's mobile device 420 would have to be near, or in range of, the beacon broadcasting the offer. In another example, the offer is provided by an application on the user's mobile device 420 after the user enters into the area defined by geo-fence 405. In yet another embodiment, the offer is provided on the user's mobile device 420 when a location capability of the user's mobile device determines that the user's mobile device 420 is located near retail store 400. In general, near retail store 400 refers to a location such as, within the bounds of the store, within a few yards of the store, within the mall in which store 400 is located, within a beacon or WiFi broadcast range of store 400, or within a block of retail store 400.

For purposes of the present discussion, the mobile device location service, can be, but is not limited to, GPS, WiFi, cellular service, beacon derived location determination and the like. Moreover, the location determined by the mobile device location service may be useful even at differing levels of accuracy. For example, a GPS enabled mobile device 420 can provide location information that is accurate to within a few meters while a cellular service, beacon or WiFi location capabilities of mobile device 420 can provide a location radius or location area. For example, the mobile device 420 being located within range of a beacon, within the overlapping area of a number of cellular service towers, etc.

For purposes of the discussion, geo-fence 405 refers to a virtual perimeter defining a real-world geographic area. Moreover, geo-fence 405 can be created by various means, one of which includes the use of beacons. For example, in FIG. 4, geo-fence 405 is a rectangle created by the locations of beacons 410-1, 410-2, 410-3, and 410-n. However, it should be appreciated that a beacon established geo-fence 405 can be any shape based on the number and location of beacons used to generate the geo-fence 405.

In general, the one or more of beacons 410-1 through 410-n are devices that are configured to be communicatively coupled with user's mobile device 420, such as via near field communication (NFC), Bluetooth, WiFi, or the like. In one embodiment, one or more of beacons 410-1 through 410-n is an iBeacon™, which is an indoor positioning system from Apple Inc. For example, the iBeacon is a low-powered, low-cost transmitter that can notify nearby iOS and/or Android devices of their presence. Although an iBeacon is provided as a specific example, the beacons are not limited to only that brand. Different beacons from other companies would also likely be acceptable.

Additionally, user's mobile device 420 can be enabled to look for the transmission of one or more of beacons 410-1 through 410-n. When user's mobile device 420 is within physical proximity to the beacon and detects it, the application can notify the user of the offer.

For example, the offer 105 may be provided to user's mobile device 420 while the user is within retail store 400 such as after the user enters geo-fence 405. In general, the offer 105 may be delivered via, a text message, e-mail, push message, other type of in App display, or the like. As described herein, the offer provides an opportunity for the user to receive an incentive.

Retail store 400 include a point of sale (POS) 430, and optionally one or more of a static offer 105, a geo-fence 405, and one or more of beacons 410-1 through 410-n. In one instance, the user's mobile device 420 may include a retail store 400 application but may not have a credit account therewith.

### Example Computer System Environment

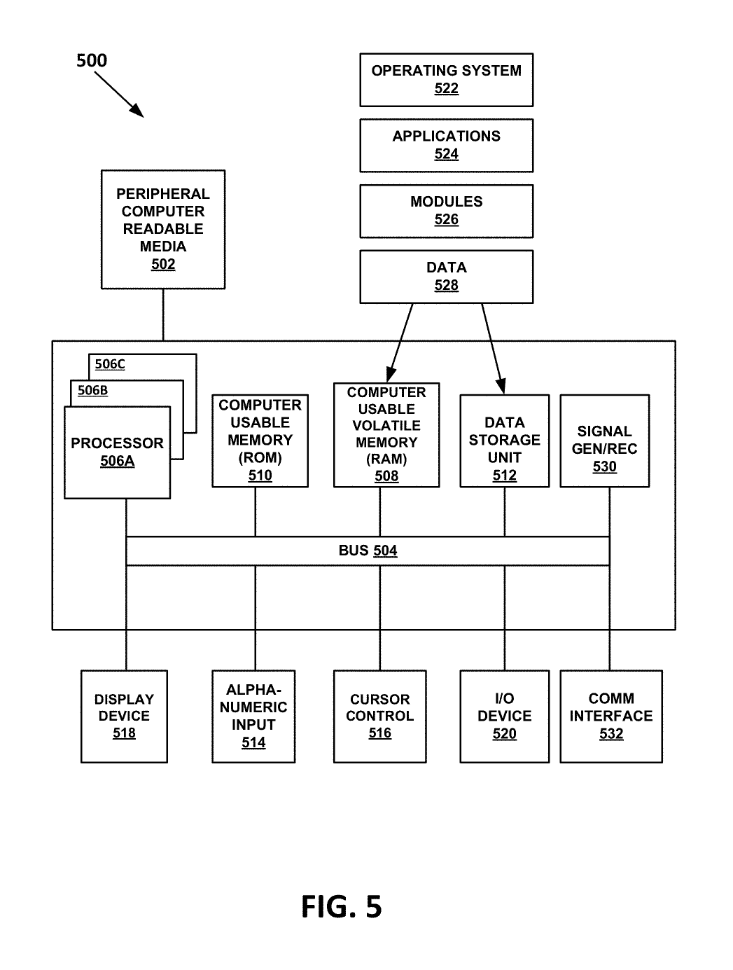

With reference now to FIG. 5, portions of the technology for providing a communication composed of computer-readable and computer-executable instructions that reside, for example, in non-transitory computer-readable storage media of a computer system. That is, FIG. 5 illustrates one example of a type of computer that can be used to implement embodiments of the present technology. FIG. 5 represents a system or components that may be used in conjunction with aspects of the present technology. In one embodiment, some or all of the components described herein may be combined with some or all of the components of FIG. 5 to practice the present technology.

FIG. 5 illustrates an example computer system 500 used in accordance with embodiments of the present technology. It is appreciated that system 500 of FIG. 5 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 5, computer system 500 of FIG. 5 is well adapted to having peripheral computer readable media 502 such as, for example, a disk, a compact disc, a flash drive, and the like coupled thereto.

Computer system 500 of FIG. 5 includes an address/data/control bus 504 for communicating information, and a processor 506A coupled to bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. Computer system 500 also includes data storage features such as a computer usable volatile memory 508, e.g., random access memory (RAM), coupled to bus 504 for storing information and instructions for processors 506A, 506B, and 506C.

System 500 also includes computer usable non-volatile memory 510, e.g., read only memory (ROM), coupled to bus 504 for storing static information and instructions for processors 506A, 506B, and 506C. Also present in system 500 is a data storage unit 512 (e.g., a magnetic disk drive, optical disk drive, solid state drive (SSD), and the like) coupled to bus 504 for storing information and instructions. Computer system 500 also includes an optional alpha-numeric input device 514 including alphanumeric and function keys coupled to bus 504 for communicating information and command selections to processor 506A or processors 506A, 506B, and 506C. Computer system 500 also includes an optional cursor control device 516 coupled to bus 504 for communicating user input information and command selections to processor 506A or processors 506A, 506B, and 506C. Optional cursor control device may be a touch sensor, gesture recognition device, and the like. Computer system 500 of the present embodiment also includes an optional display device 518 coupled to bus 504 for displaying information.

Referring still to FIG. 5, optional display device 518 of FIG. 5 may be a liquid crystal device, cathode ray tube, OLED, plasma display device or other display device suitable for creating graphic images and alpha-numeric characters recognizable to a user. Optional cursor control device 516 allows the computer user to dynamically signal the movement of a visible symbol (cursor) on a display screen of display device 518. Many implementations of cursor control device 516 are known in the art including a trackball, mouse, touch pad, joystick, non-contact input, gesture recognition, voice commands, bio recognition, and the like. In addition, special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

System 500 is also well suited to having a cursor directed by other means such as, for example, voice commands. Computer system 500 also includes an I/O device 520 for coupling system 500 with external entities. For example, in one embodiment, I/O device 520 is a modem for enabling wired or wireless communications between system 500 and an external network such as, but not limited to, the Internet or intranet. A more detailed discussion of the present technology is found below.

Referring still to FIG. 5, various other components are depicted for system 500. Specifically, when present, an operating system 522, applications 524, modules 526, and data 528 are shown as typically residing in one or some combination of computer usable volatile memory 508, e.g. random access memory (RAM), and data storage unit 512. However, it is appreciated that in some embodiments, operating system 522 may be stored in other locations such as on a network or on a flash drive; and that further, operating system 522 may be accessed from a remote location via, for example, a coupling to the internet. In one embodiment, the present technology, for example, is stored as an application 524 or module 526 in memory locations within RAM 508 and memory areas within data storage unit 512. The present technology may be applied to one or more elements of described system 500.

System 500 also includes one or more signal generating and receiving device(s) 530 coupled with bus 504 for enabling system 500 to interface with other electronic devices and computer systems. Signal generating and receiving device(s) 530 of the present embodiment may include wired serial adaptors, modems, and network adaptors, wireless modems, and wireless network adaptors, and other such communication technology. The signal generating and receiving device(s) 530 may work in conjunction with one or more communication interface(s) 532 for coupling information to and/or from system 500. Communication interface 532 may include a serial port, parallel port, Universal Serial Bus (USB), Ethernet port, Bluetooth, thunderbolt, near field communications port, WiFi, Cellular modem, or other input/output interface. Communication interface 532 may physically, electrically, optically, or wirelessly (e.g., via radio frequency) couple computer system 500 with another device, such as a mobile phone, radio, or computer system.

The computing system 500 is only one example of a suitable computing environment and is not intended to suggest any limitation as to the scope of use or functionality of the present technology. Neither should the computing environment be interpreted as having any dependency or requirement relating to any one or combination of components illustrated in the example computing system 500.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A non-transitory computer-readable storage medium having instructions embodied therein that when executed cause a computer system to perform a method for mobile credit acquisition with form population, the method comprising:
receiving a device identifier associated with a user's mobile device, said receiving in response to a user responding to a credit account offer via said user's mobile device;
receiving a user identifier for said user;
utilizing the device identifier and the user identifier for obtaining a user specific information useable for populating an application form for said credit account offer, said obtaining the user specific information comprising:
performing a proprietary database search for the user specific information; and
returning found user specific information, wherein if no user specific information is found;
performing a secondary source database search for the user specific information;
returning found user specific information; and
utilizing the found user specific information to prepopulate an application form for said credit account offer to be presented to said user via said user's mobile device.

2. The non-transitory computer-readable storage medium of claim 1, wherein performing the proprietary database search comprises:
searching one or more databases from the group consisting of: a company specific database, and a shared customer database.

3. The non-transitory computer-readable storage medium of claim 1, wherein if said user specific information is found during the performing of the proprietary database search, the method further comprises:
utilizing a confidence factor threshold to validate said user specific information, such that only user specific information above said confidence factor threshold is utilized to populate the application form.

4. The non-transitory computer-readable storage medium of claim 3, wherein if said user specific information is found during the performing of the proprietary database search is below said confidence factor threshold, the method further comprises:
attempting to validate the user specific information obtained from the proprietary database search, such that only validated user specific information is utilized to populate the application form.

5. The non-transitory computer-readable storage medium of claim 1, wherein performing the secondary source database search comprises:
searching a reverse phone number look up database.

6. The non-transitory computer-readable storage medium of claim 1, wherein performing the secondary source database search comprises:
searching one or more databases from the group consisting of: a social media site, a search engine, an online public record storage, and an online private record storage.

7. The non-transitory computer-readable storage medium of claim 1 further comprising:
receiving both said user identifier and said device identifier in a single message from said user's mobile device.

8. The non-transitory computer-readable storage medium of claim 1 further comprising:
receiving at least two user identifiers in a single message from said user's mobile device.

9. The non-transitory computer-readable storage medium of claim 1, further comprising:
performing a credit prescreen with the user specific information at a credit reporting agency.

10. A mobile credit acquisition with form population system comprising:
a user specific information engine to receive a device identifier associated with a user's mobile device and a user identifier for a user of said user's mobile device;
the user specific information engine to use the device identifier and the user identifier to search for a user specific information useable to populate an application form for a credit account, said search comprising:
a proprietary database search for the user specific information, wherein if no user specific information is found;
a secondary source database search for the user specific information; and
an incentive provider to populate the application form for said credit account with a found user specific information and provide the populated application form for said credit account to said user via said user's mobile device.

11. The system of claim 10 wherein the proprietary database search comprises:
a company specific database; and
a shared customer database.

12. The system of claim 10 further comprising:
a confidence factor threshold to validate the found user specific information, such that only found user specific information above said confidence factor threshold is utilized to populate the application form.

13. The system of claim 10 further comprising:
a validation database to validate the user specific information obtained from the proprietary database search, such that only validated user specific information is utilized to populate the application form.

14. The system of claim 10 wherein said secondary source database is a reverse phone number look up database.

15. The system of claim 10 wherein said secondary source database search comprises one or more databases from the group consisting of: a social media site, a search engine, an online public record storage, and an online private record storage.

16. The system of claim 10 wherein the device identifier is a user's mobile device phone number and the user identifier is a user's zip code.

17. The system of claim 10 wherein the user specific information is selected from the group consisting of at least two of: a name, at least a partial address, a driver's license number, and a social security number.

18. The system of claim 10 wherein both said user identifier and said device identifier is provided in a single message from said user's mobile device.

19. A non-transitory computer-implemented method for mobile credit acquisition with form population, the method comprising:
responding electronically to a credit account offer via a mobile device;
providing a zip code associated with a user of the mobile device in said responding; and
receiving a populated credit offer form at said mobile device, where the populated credit offer form includes more user specific information than what was initially provided.

20. The non-transitory computer-implemented method of claim 19, wherein the user specific information is selected from the group consisting of at least two of: a name, at least a portion of an address, a driver's license number, and a social security number.
